(19) United States
(12) Patent Application Publication
(10) Pub. No.: US 2005/0133748 A1
(43) Pub. Date: Jun. 23, 2005

(54) Raster scanning system for scanning photo-stimulatable radiographic media

(75) Inventors: Roger S. Kerr, Brockport, NY (US); Seung-Ho Baek, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/745,380

(22) Filed: Dec. 22, 2003

(51) Int. Cl. G03B 42/08

(52) U.S. Cl. 250/584

(57) ABSTRACT

A raster scanning system for scanning photo-stimulatable radiographic media (14) comprises a flying spot light source (10) adapted to fire a beam (11) at a rotating mirror (12) to form a stimulated area (13) of radiographic media generating emitted light (15). Collection optics (16) collect the emitted light and reflected light (17) from the radiographic media. A filter (18) permits the emitted light to pass to a charge coupled detector (CCD) (20). An analog to digital converter (22) receives the signal from the CCD. A control process unit (CPU) (24) receives the converted signal. An output device (26) processes the signal from the CPU.

### FIELD OF THE INVENTION

This invention relates in general to radiography and in particular to scanning a computer radiographic phosphor plate having a latent image to generate a digital image file by means of a scanning apparatus having a modulated flying spot scanning beam and CCD sensor array.

### BACKGROUND OF THE INVENTION

In a photo-stimulatable phosphor imaging system, as described in U.S. Patent No. RE 31,847, a photo-stimulatable phosphor sheet is exposed to an image wise pattern of short wavelength radiation, such as x-radiation, to record a latent image pattern in the photo-stimulatable phosphor sheet. The latent image is read out by stimulating the phosphor with a relatively long wavelength stimulating radiation such as red or infrared light. Upon stimulation, the photo-stimulatable phosphor releases emitted radiation of an intermediate wavelength such as blue or violet light in proportion to the quantity of short wavelength radiation that was received. To produce a signal useful in electronic image processing, the photo-stimulatable phosphor sheet is scanned in a raster pattern by a beam of light to produced emitted radiation, which is sensed by a photo-detector such as a photo-multiplier tube to produce the electronic image signal. The signal is then transmitted to a separate device, a film writer, which reproduces the scanned image.

While the above system works well a need exists to improve image quality along with scanning rates.

### SUMMARY OF THE INVENTION

Briefly, according to one aspect of the present invention a raster scanning system for scanning photo-stimulatable radiographic media comprises a flying spot light source adapted to fire a beam at a rotating mirror to form a stimulated area of radiographic media generating emitted light. Collection optics collect the emitted light and reflected light from the radiographic media. A filter permits the emitted light to pass to a charge coupled detector (CCD). An analog to digital converter receives the signal from the CCD. A control process unit (CPU) receives the converted signal. An output device processes the signal from the CPU.

The invention and its objects and advantages will become more apparent in the detailed description of the preferred embodiment presented below.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with accompanying drawings.

FIG. 1 is a single scan embodiment of the present invention;

FIG. 2 is a perspective view of FIG. 1;

FIG. 3 is a schematic view of a dual scanning system of the present invention with a single source of stimulation; and

FIG. 4 is a schematic view of a dual scanning system of the present invention with a dual side stimulation of the radiographic media.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

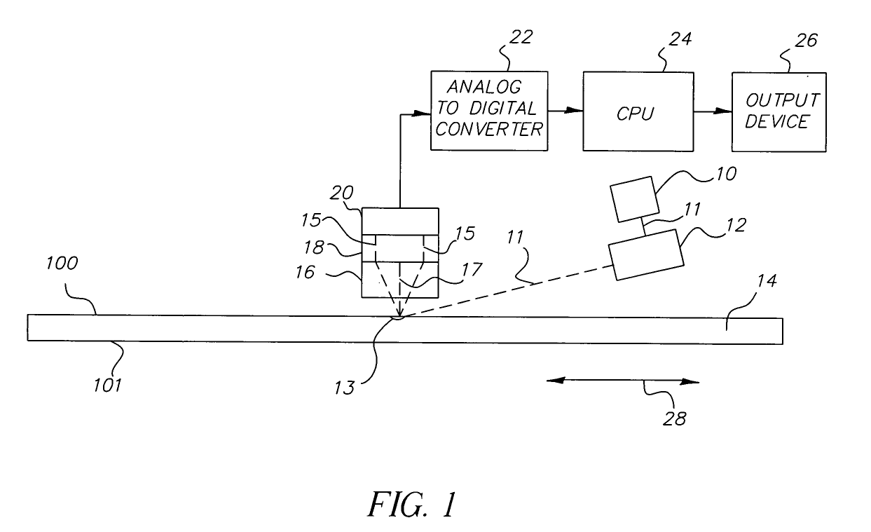

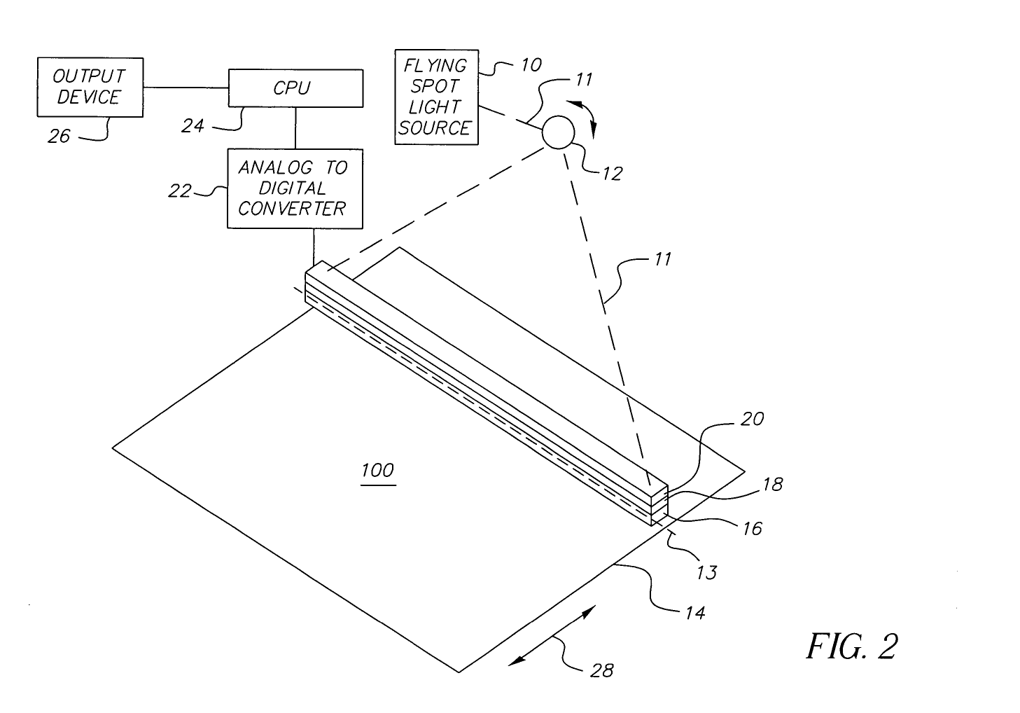

Referring now to FIGS. 1 and 2 is a system includes a raster scanning system for scanning photo-stimulatable radiographic media 14. It uses a flying spot light source 10 adapted to fire a beam 11 at a rotating mirror 12 to form a stimulated area 13 of radiographic media 14 generating emitted light 15. Collection optics 16 which can be an optical lens system to collect emitted light 15 and the reflected light 17 from the radiographic media. The collection optics 16 are elliptical in one embodiment. A blue filter 18 permits the emitted light 15 to pass to a charge coupled detector (CCD) 20. The filter does not permit the reflected light to pass to the CCD. An analog to digital converter 22 receives the signal from the CCD. A control processing unit (CPU) 24 receives the converted signal from the analog to digital converter 22. An output device 26 is in communication with the CPU for processing the signal. While scanning, the radiographic media 14 moves along axis 28 to allow scanning of larger portions, and up to the entire sheet of radiographic media.

The radiographic media 14 has a first side 100 and a second side 101. The area 13 to be stimulated can be a series of stimulated areas. The radiographic media can be a phosphor sheet. The media is a sheet, a screen, a plate, or combinations thereof.

In a preferred embodiment, the mirror rotates at a rate of between 4,000 rpm and 30,000 rpm.

The laser can be a flying spot light source such as a laser which is a single mode or a multiple mode laser. Preferably, the multimode laser is a 635 nanometer, 100 mW laser. Preferably the single mode laser is a 635 nanometer 100 mW laser.

The collection optics are preferably a chamber comprising a reflective surface, such as a mirrored surface.

The invention provides a set of collection optics which provide a reflectivity between 80 and 95%.

In a preferred embodiment, the output device is a filmwriter, a printer or a display.

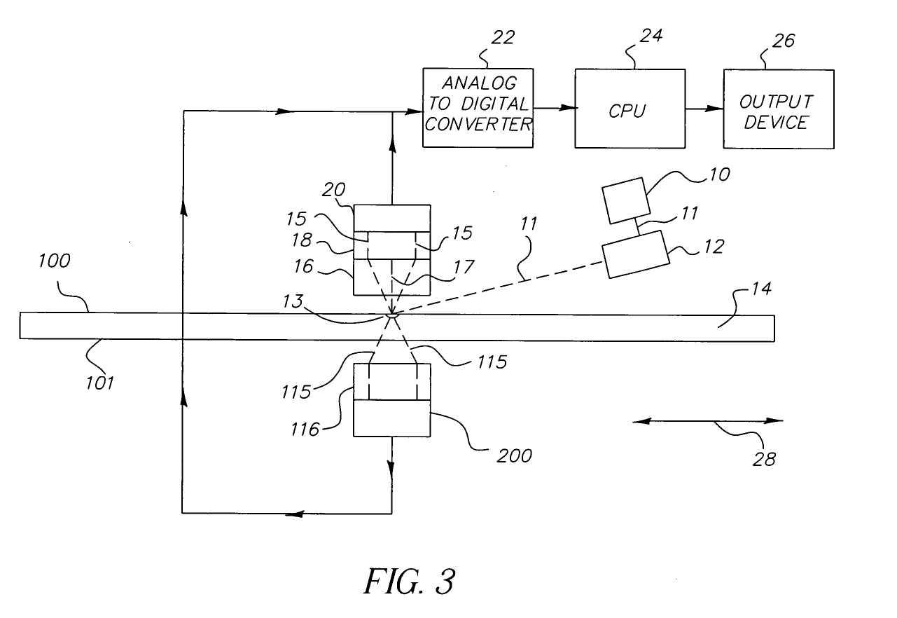

In another embodiment of the invention, as shown in FIG. 3, is a scanning system for scanning photo-stimulatable radiographic media from a first side 100 and a second side 101 of the radiographic media 14.

It involves a flying spot light source 10 adapted to fire a beam 11 at a rotating mirror 12 to stimulate an area 13 of radiographic media 14 generating emitted light 15 and second emitted light 115. The first emitted light 15 and reflected light 17 are collected by the first collection optics 16 and the second emitted light is collected by the second collection optics 116 which is on the side of media opposite the first collection optics 16.

The second collection optics 116 communicates with a second CCD 200 which then generates a second signal and then transmits that second signal to the analog to digital converter 22.

A blue filter 18 permits the emitted light 15 to pass to the first charge coupled detector (CCD) 20 without passing the reflected light 17. The analog to digital converter 22 receives the signals from the first and second CCDs and transmits the signal to a control CPU 24 for receiving and compiling the converted signals. An output device communicates with the CPU for processing the signal from the CPU to a filmwriter or it can be a display.

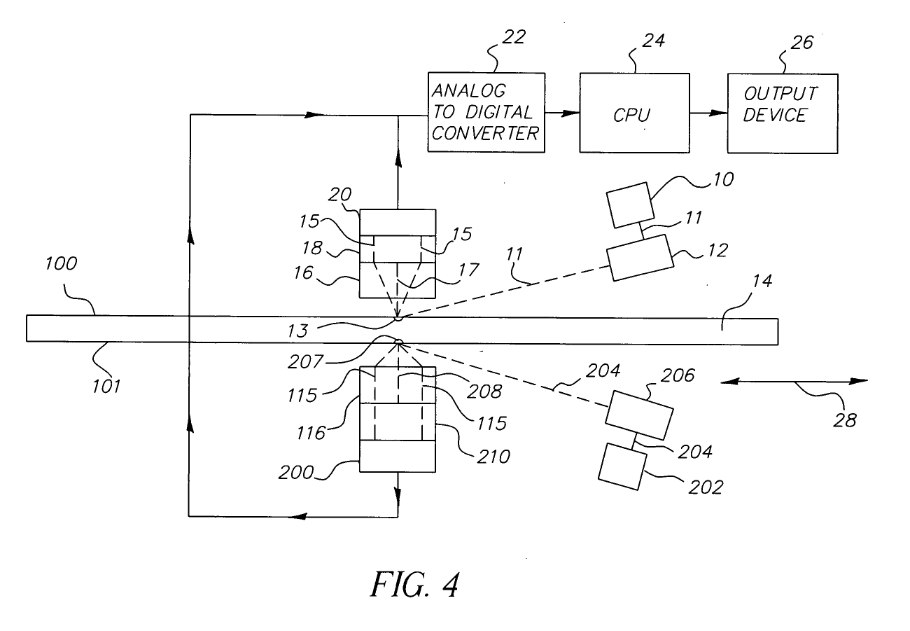

FIG. 4 shows another embodiment of the present invention. In this version, radiographic media 14 has a first and second side 100 and 101 respectively. This embodiment has all the elements shown in FIG. 1, but additionally has, on the second side of the radiographic media, a second flying spot light source 202 which provides a second beam 204 to a second rotating mirror 206. This second beam 204 stimulates a second area 207 causing a second emitted light 115 from the radiographic media. Second reflected light 208 is reflected from the surface of the radiographic media and both the second reflected light and the second emitted light are collected by second collection optics 116. A second filter 210 communicates with the second collection optics to stop the second reflected light from passing to a second CCD 200. Preferably the second filter is a blue filter as in FIG. 1. Light in the second CCD is converted to a signal which is transmitted to the analog to digital converter 22. As in FIG. 1, the signal is converted to a digital signal and then transmitted to a CPU 24 which compiles and stores the signals. The signals can be transferred to an output device, such as filmwriter 26. It is contemplated that more than one output device can be used in the scope of this invention.

The invention has been described in detail with particular reference to certain preferred embodiments thereof, but it will be understood that variations and modifications can be effected within the scope of the invention.

### Parts List

10 flying spot light source
11 beam
12 rotating mirror
13 stimulated area
14 radiographic media
15 emitted light from stimulated area
16 first collection optics
17 reflected light
18 blue filter
20 first charge coupled detector (CCD)
22 analog to digital converter
24 control processing unit (CPU)
26 output device
28 axis
100 first side of radiographic media
101 second side of radiographic media
115 second emitted light
116 second collection optics
200 second charge coupled detector (CCD)
202 second flying spot light source
204 second beam
206 second rotating mirror
207 second stimulated area
208 second reflected light
210 second filter

1. A raster scanning system for scanning photo-stimulatable radiographic media, comprising:
a) a flying spot light source adapted to fire a beam at a rotating mirror to form a stimulated area of radiographic media generating emitted light;
b) collection optics to collect emitted light and reflected light from the radiographic media;
c) a filter which permits the emitted light to pass to an array of charge coupled detectors (CCD);
d) an analog to digital converter for receiving and converting a signal from the CCD;
e) a control process unit (CPU) for receiving the converted signal; and
f) an output device for processing the signal from the CPU.

2. The system of claim 1 wherein the flying spot light source creates a series of stimulated areas.

3. The system of claim 1 wherein the radiographic media is a phosphor sheet.

4. The system of claim 1 wherein the radiographic media is a sheet, a screen, a plate, or combinations thereof.

5. The system of claim 1 wherein the mirror rotates at a rate of between 4,000 rpm and 30,000 rpm.

6. The system of claim 1 wherein the flying spot light source is a laser.

7. The system of claim 1 wherein the collection optics comprise a chamber further comprising a reflective surface.

8. The system of claim 1 wherein the radiographic media moves along an axis perpendicular to the stimulated line.

9. The system of claim 7 wherein the reflective surface is a mirrored surface.

10. The system of claim 1 wherein the collection optics provide a reflectivity between 80 and 95%.

11. The system of claim 6 wherein the laser is a multimode 635 nanometer, 100 mW laser or a single mode 635 nanometer 100 mW laser.

12. The system of claim 1 wherein the filter is blue.

13. The system of claim 1 wherein the collection optics has a collection efficiency of approximately 52%.

14. The system of claim 1 wherein the output device is a filmwriter, a printer or a display.

15. The system of claim 1 wherein the collection optics are elliptical.

16. A raster scanning system for scanning photo-stimulatable radiographic media, comprising:
a) a light source adapted to stimulate an area of radiographic media generating emitted light wherein said radiographic media has a first side and a second side;
b) a first collection optics to collect emitted light and reflected light disposed on a first side of radiographic media and a second collection optics to collect second emitted light disposed on a second side of the radiographic media;
c) a filter to permit the emitted light to pass to a charge coupled to a first charge coupled detector (CCD);
d) a second charge coupled detector disposed on the second side to and in communication with the second collection optics;
e) an analog to digital converter for receiving the signals from the first and second CCDs;
f) a control processing unit (CPU) for receiving and compiling the converted signal; and
g) an output device for processing the signal from the CPU.

17. The system of claim 16 wherein the area is a series of stimulated areas.

18. The system of claim 16 wherein the radiographic media is a phosphor sheet.

19. The system of claim 16 wherein the radiographic media is a sheet, a screen, a plate, or combinations thereof.

20. The system of claim 16 wherein the mirror rotates at a rate of between 4,000 rpm and 30,000 rpm.

21. The system of claim 16 wherein the flying spot light source is a laser.

22. The system of claim 16 wherein the first and second collection optics are each a chamber comprising a reflective surface.

23. The system of claim 16 wherein the radiographic media moves along an axis perpendicular to the stimulated line.

24. The system of claim 22 wherein the reflective surface is a mirrored surface.

25. The system of claim 16 wherein the collection optics provide a reflectivity between 80 and 95%.

26. The system of claim 21 wherein the laser is a multimode 635 nanometer, 100 mW laser or a single mode 635 nanometer 100 mW laser.

27. The system of claim 16 wherein the filter is blue.

28. The system of claim 16 wherein the collection optics has a collection efficiency of approximately 52%.

29. The system of claim 1 further comprising a second laser and a second mirror disposed on the second side of the radiographic media to stimulate a second area for emitting light.
